(19) United States
(12) Patent Application Publication
(10) Pub. No.: US 2011/0035948 A1
(43) Pub. Date: Feb. 17, 2011

(54) Adjustable Scraper

(76) Inventor: Scott Wang, Renton, WA (US)

Correspondence Address: Chien-Hui Su, P. O. Box 70-121 Taichung, Taichung City, 40899, TW

(21) Appl. No.: 11/556,036

(22) Filed: Nov. 2, 2006

(51) Int. Cl. B26B 3/00

(52) U.S. Cl. 30/169

(57) ABSTRACT

The invention is an adjustable scraper having an elongated blade holder with a guide slot. A release button in the scraper's handle permits the blade holder to be selectively extended or retracted at different positions relative to the handle for adjusting the overall length of the scraper.

### TECHNICAL FIELD

The invention described here relates to hand tools and, more particularly, an adjustable scraper.

### SUMMARY OF DISCLOSURE

An adjustable scraper for scraping paint and the like has a quick release button that enables the extension and retraction of a scraper blade relative to the scraper's handle. The blade is connected to an extension arm, or blade holder, that can slide in and out relative to the scraper's handle. The blade holder has an elongated slot that is uniform in width, with the exception of enlarged spaces or areas that are positioned at regular intervals along the slot's length. These areas define a circular catch space that has a diameter that is larger than the normal width of the slot.

The quick release button is spring-loaded and serves to hold the blade holder at certain extended or retracted positions, or to release the blade holder for sliding movement in and out of the handle, as the case may be. The button is made from two parts that are screwed together, or joined together in a conventional way, each having a slightly different diameter. These two parts extend through the scraper's handle and the slot in the blade holder, respectively. Depending on the vertical position of the button, the blade holder is either held in position or released.

The above summary and certain other aspects of the design disclosed here will become more clear upon review of the following text which is to be read in conjunction with the illustrations that make up part of this disclosure.

### BRIEF DESCRIPTION OF THE DRAWINGS

Like reference numerals and letters refer to like parts throughout the various views, and wherein:

FIG. 1 is an exploded pictorial view of an adjustable scraper constructed in accordance with the invention;

FIG. 2 is a pictorial view of the scraper shown in FIG. 1;

FIG. 3 is a top view of the scraper shown in FIGS. 1-2;

FIG. 4 is a cross-sectional view of the scraper's quick release button;

FIG. 5 is a side cross-sectional view of the forward end of the scraper shown in FIGS. 3-4, but shows the blade in an extended position; and

FIG. 6 is a side cross-sectional view of the forward end of the scraper shown in FIGS. 3-4, but shows the blade in a retracted position.

### BEST MODE FOR CARRYING OUT THE INVENTION

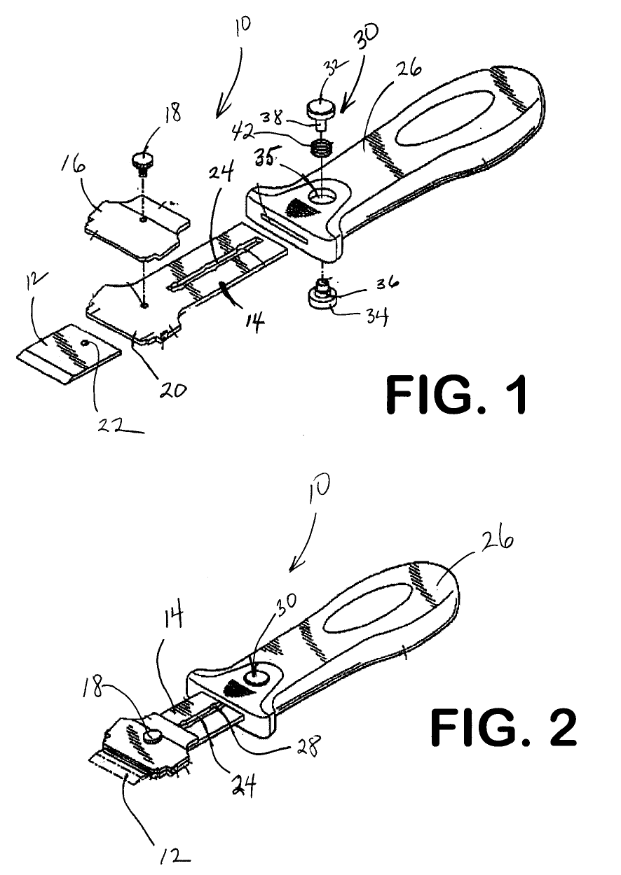

Referring now to the drawings, and first to FIG. 1, shown generally at 10 is an adjustable scraper constructed in accordance with the invention. The scraper 10 has a replaceable blade 12 that is captured on the end of an extension arm 14 by a blade holder plate 16. A screw 18 sandwiches the blade 12 between the blade holder plate 16 and an end portion 20 of the extension arm 14. Hereafter, the extension 14 will be referred to as the “blade holder.” The screw 18 also passes through a small bore 22 in the blade 12 that assists holding the blade in place. Obviously, removing the screw 18 permits the blade 12 to be removed for either replacement or sharpening.

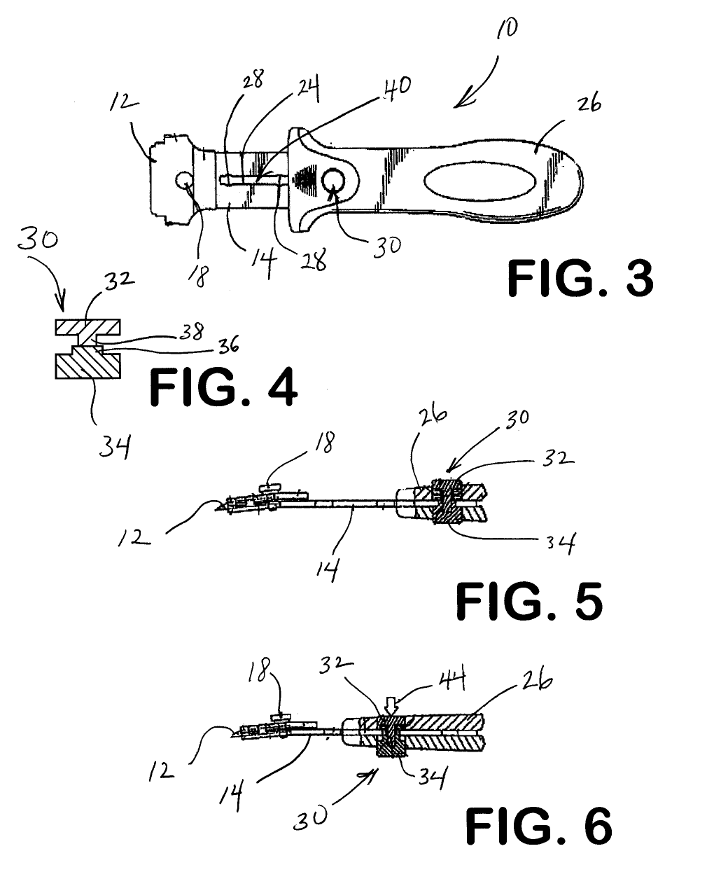

The blade holder 14 has an elongated slot 24 that serves as both an extension/retraction guide and a mechanism for holding the blade holder 14 in certain positions relative to the scraper's handle 26. Referring to FIG. 3, for example, the slot 24 has a uniform width for most of its length, with the exception of enlarged areas 28 that are spaced at regular intervals along the length of the slot. These enlarged areas are circular and create an enlarged “catch” for capturing a pin that is oversized relative to the normal width of the slot 24.

Received within the handle 26 is a spring-biased push button, indicated generally at 30. The push button is made of two parts 32, 34, that are inserted from opposite sides of the handle 26, through a bore 35 that extends through the handle. The ends of these two push button parts are either screwed together or otherwise joined in a conventional way. However, one part 34 has a slightly larger diameter (see 36 in FIGS. 1 and 4) that is sized to mate within the enlarged spaces 28 in the extension arm 14. The other part 32 has a narrower diameter (see 38 in FIGS. 1 and 4) that is sized to run along the normal width (the region generally indicated at 40 in FIG. 3) of the slot 24.

A spring 42 normally pushes the button 30 upwardly (or vertically upwardly when using the drawings as a frame of reference), so that the larger diameter piece 36 will be in engagement with one of the enlarged circular areas 28 in the blade holder 14, thus holding it at a certain extended or retracted position relative to the handle 26. FIG. 5 is representative. Pushing the button 30 downwardly, as indicated at 44 in FIG. 6, puts the narrower part 38 of the button in the extension arm's slot 24, thus allowing it to be slid in or out of the handle 26. FIG. 6 shows the arm in a retracted position.

The push button 30 allows for a quick lengthwise adjustment of a scraper tool. As is apparent from the drawings, the blade holder 14 is shaped like a flat bar that fits within a similarly shaped recess 46 in the scraper's handle 26.

The foregoing description describes a single embodiment of the invention and is not intended to limit the scope of the patent right. The scope of the patent protection is to be limited in accordance with the applicable doctrines relating to patent interpretation and not limited by the specifics of the foregoing description.

I claim:

1. A scraper tool, comprising:
a blade holder that is extendible and retractable relative to a handle, the blade holder having an elongated slot with spaced apart enlarged areas along the slot, a button member extending through the handle having one cylindrical portion that is sized to slide through the slot and a second cylindrical portion that is too large to slide through the slot but is instead sized to fit into registration with each one of the enlarged areas, the button member being spring biased to normally urge the second cylindrical portion into registration with one of the enlarged areas.
